(19) United States
(12) Patent Application Publication
(10) Pub. No.: US 2003/0110510 A1
(43) Pub. Date: Jun. 12, 2003

(54) Frontend media filter for digital TV broadcast

(76) Inventors: Hubert Le Van Gong, Santa Clara, CA (US); Sidney Wang, Pleasanton, CA (US)

Correspondence Address: Andre M. Gibbs, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/015,019

(22) Filed: Dec. 10, 2001

(51) Int. Cl. H04N 7/173; H04N 5/445

(52) U.S. Cl. 725/127; 725/46

(57) ABSTRACT

A method and apparatus to filter a plurality of multimedia streams of a presentation is described. According to one embodiment, a filtering apparatus receive user profile information describing user preferences and a plurality of multimedia streams including metadata streams. The metadata streams describe each of the plurality of multimedia streams. The filtering apparatus filters the plurality of multimedia streams to select a multimedia stream based on the metadata and the user profile information.

### CROSS-REFERENCE TO RELATED APPLICATIONS

Not Applicable.

### BACKGROUND OF THE INVENTION

1. Field of the Invention

The invention relates generally to data communications and, more particularly, to a frontend media filter for a digital TV broadcast.

2. Background of the Invention

With the advent of digital TV, a viewer receives much more information on television than ever. This information is presented in the form of multiple multimedia streams (e.g., audio/video and data streams). For example, a digital TV broadcast of a car race may present the viewer with different audio/video (AV) feeds like in-car views, pit stops, a fight between several drivers, etc. In addition, the digital TV multimedia streams may also present the viewer with a huge amount of data, such as, telemetry data produced by each car during the race, driver statistics, etc.

The dramatic increase of audio/video and data multimedia streams via digital TV to the viewer may overwhelm or detract the viewer from the many advantages of the digital TV experience.

### BRIEF SUMMARY OF THE INVENTION

A method and apparatus to filter a plurality of multimedia streams of a presentation. According to one embodiment, a filtering apparatus receive user profile information describing user preferences and a plurality of multimedia streams including metadata streams. The metadata streams describe each of the plurality of multimedia streams. The filtering apparatus filters the plurality of multimedia streams to select a multimedia stream based on the metadata and the user profile information.

### BRIEF DESCRIPTION OF THE DRAWINGS

The invention may best be understood by referring to the following description and accompanying drawings that are used to illustrate embodiments of the invention. In the drawings:

FIG. 1 illustrates one embodiment of an exemplary system according to one embodiment of the invention.

FIG. 2 illustrates a flow diagram according to one embodiment of the invention.

FIG. 3 depicts an exemplary computer system suitable for practicing the present invention.

### DETAILED DESCRIPTION OF THE INVENTION

In the following description, for purposes of explanation, numerous details are set forth in order to provide a fair understanding of the present invention. However, it will be apparent to one skilled in the art that these specific details are not required in order to practice the present invention.

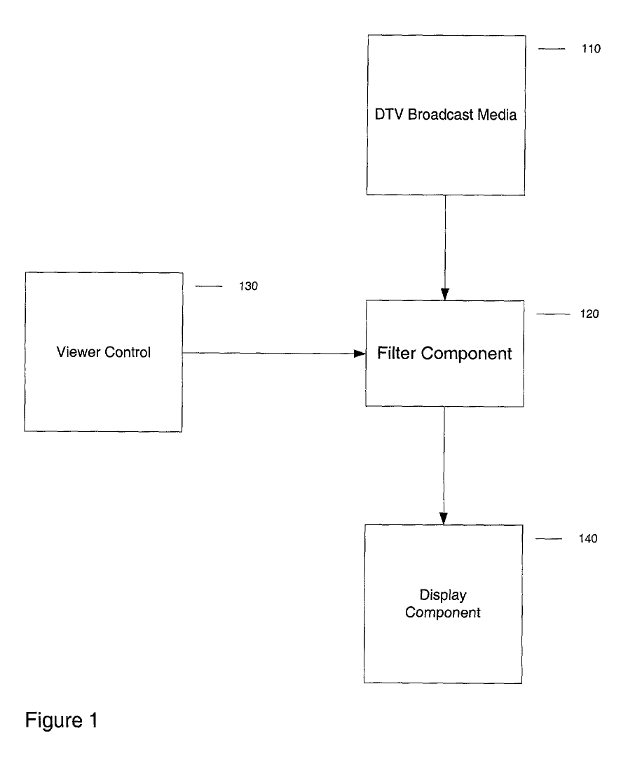

The system of the present invention provides for the filtering of a digital TV broadcast. A simplified block diagram of one embodiment of an exemplary system is illustrated in FIG. 1. A digital TV broadcast media 110 is coupled to a filter component 120 that provides selected multimedia streams from a plurality of available multimedia streams to the display component 140. In one embodiment, the filter component 120 may be part of a frontend media filter incorporated into a broadband or broadcast device, including but not limited to a digital TV receiver, a set top box, and a personal computer, among other examples.

In one embodiment, the plurality of multimedia streams include audio/video, graphics, data, and metadata streams. The audio/video streams may include audio and video produced from, for example, a plurality of broadcast cameras broadcasting a specific presentation. The data streams may be produced from telemetry data associated with the audio/video stream. The metadata streams describes characteristics of part or all of each of the plurality of associated multimedia streams of a specific presentation. Metadata can also describe relationships between different streams. In one embodiment, a metadata stream is not meant to be presented to the viewer. In contrast, a data stream includes information directly viewable by the viewer.

In addition, in one embodiment, the digital TV broadcast media 110 may also include simulated multimedia streams of a broadcast presentation. An example in which simulated multimedia may be integrated with an actual multimedia stream is further described in the patent application entitled “Enhancing Broadcast with Synthetic Camera Views” to Sidney Wang, et al., filed on Aug. 29, 2001, Ser. No. 09/943,044. The Wang application describes how a synthetic scene may be generated and integrated with video including live video. Simulated multimedia may be integrated with a multimedia stream before or after the filtering process as will be further described.

In one embodiment, the multimedia streams are transmitted from a server, such as one operated by a broadcast/broadband service provider supplying the broadcast presentation (e.g., of a car race). It is readily apparent that this information may be supplied, not only over the service provider's media, but over a variety of media including the Internet.

The digital TV broadcast media 110 may deliver to the filter component 120 numerous multimedia streams of the same broadcast presentation (e.g., the same car race) or of multiple broadcast presentations (e.g., a picture within a picture). As will be described below, the filter component 120 may be used to selectively filter the multimedia streams received from the digital TV broadcast media 110 to provide only the selected multimedia streams to the viewer via the display component 140.

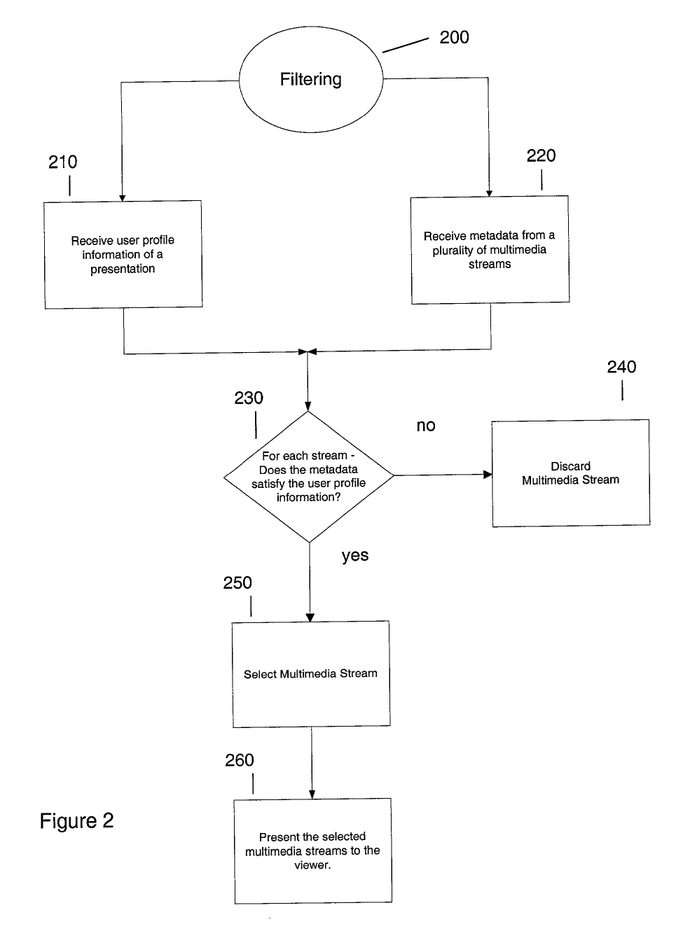

FIG. 2 illustrates a flow diagram according to one embodiment of the invention. The following example illustrates filtering method 200 used by the filter component 120 of FIG. 1 to filter a digital TV broadcast media 110.

At block 210, a viewer uses the viewer control 130 to supply user profile information to the filter component 120. The viewer control 130 may be a physical control device, such a television remote control, a graphical user interface, and the like. The user profile information describe user preferences that determine the multimedia streams to be selectively presented to the viewer. For example, to continue the car race scenario, the viewer may selectively chose to only view one driver, view the statistics of one driver (e.g., telemetry data), and/or only view the first ten cars, among other examples. According to one embodiment, the user profile information is stored in the filter component 120.

At block 220, the filter component receives a plurality of multimedia streams, including associated metadata stream(s). To continue the example, a specific stream may include audio/video of a specific driver and a specific data stream containing telemetry data for identification purposes, such as, a lap time that is associated to driver. The metadata would describe the characteristics of these specific audio/video (e.g., of the specific driver) and data streams (e.g., lap time telemetry data of the specific driver) as well as potential relationships between these streams.

At block 230, upon receiving the user profile information and the metadata associated with the plurality of multimedia streams, for a broadcast presentation, the filter component 120 determines whether the metadata satisfies the user profile information. If the filter component determines that the metadata satisfies the user profile information, then control passes to block 250. If the filter component determines that the metadata does not satisfy the user profile information, then control passes to block 240. In one embodiment, satisfaction may be determined from positive or negative criteria. Satisfaction may be determined from the user profile information having a request for specific information (positive criteria) or the viewer may also request that a specific multimedia stream not be shown (negative criteria). For example, the user profile information may include a criteria to never see “pit row” during a race (e.g., a negative criteria).

At block 240, the multimedia streams associated with the non-satisfactory metadata received from the digital TV broadcast are discarded and not presented to the display component 140.

At block 250, the filter component 120 selects the associated multimedia streams for viewing.

At block 260, one or more of the selected multimedia streams are presented to the display component 140 for display to the viewer. In one embodiment, the viewer, via the viewer control 130, may transfer the selected multimedia to a data store. In this way, the viewer may rewind, hold, and/or play the selected multimedia streams from the data store at other time.

It should be understood that in one embodiment the processing at block 230 accesses and uses the user profile information associated with the plurality of multimedia streams for the same broadcast presentation being presented to the viewer. For example, if the viewer is watching a car race the filtering process 200 accesses the associated user profile information for the car race. If the viewer changes the television to a baseball game broadcast presentation, the filtering process accesses and uses the user profile information for the plurality of multimedia streams for the baseball game broadcast presentation. However, in one embodiment, both presentations may be displayed to the viewer at the same time (e.g., a picture within a picture).

In one embodiment, at block 230, the filtering process 200 includes the most updated user profile information. Hence, if the viewer updates the user profile information while selected multimedia streams are being presented to the viewer, upon receiving the updated profile information, the filter process 200, determines whether the metadata satisfies the updated user profile information and presents the selected multimedia streams. For example, if during the car race the viewer updates the user profile information to request to view the lead driver, the filtering process 200 selects the appropriate multimedia stream from the plurality of multimedia streams to present views of the lead driver. In this way, the viewer may seamlessly update user profile information and receive updated selected multimedia streams.

As stated above, the digital TV broadcast media 110 may include actual and/or simulated multimedia streams. In one embodiment, a simulation server coupled with the filter component 120 generates and integrates simulated multimedia to the selected multimedia streams after the filtering process of a plurality of multimedia streams. In this way, the simulation server will not waste processing cycles to generate and integrate simulated multimedia streams with multimedia streams that may ultimately be ignored in the filtering process. However, in alternative embodiments, the simulated multimedia is generated and integrated into the plurality of multimedia streams before the filter process is performed on the plurality of multimedia streams.

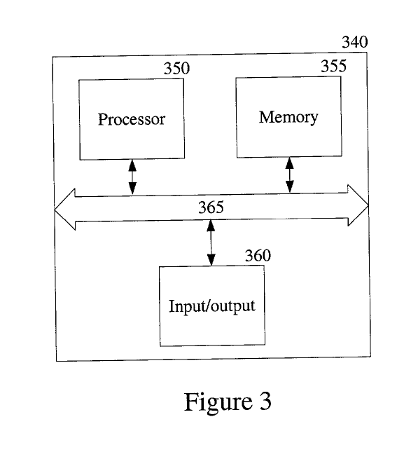

One embodiment of a computer system suitable for use as a filter component 120 is illustrated in FIG. 3. The computer system 340, includes a processor 350, memory 355 and input/output capability 360 coupled to a system bus 365. The memory 355 is configured to store instructions which, when executed by the processor 350, perform the methods described herein. The memory 355 may also store the user profile information and one or more selected multimedia streams. Input/output 360 provides for the delivery and display of the one or more multimedia streams or portions or representations thereof. Input/output 360 also encompasses various types of computer-readable media, including any type of storage device that is accessible by the processor 350.

The description of FIG. 3 is intended to provide an overview of computer hardware and other operating components suitable for implementing the invention, but is not intended to limit the applicable environments. It will be appreciated that the computer system 340 is one example of many possible computer systems which have different architectures. A typical computer system will usually include at least a processor, memory, and a bus coupling the memory to the processor. One of skill in the art will immediately appreciate that the invention can be practiced with other computer system configurations, including multiprocessor systems, minicomputers, mainframe computers, and the like. The invention can also be practiced in distributed computing environments where tasks are performed by remote processing devices that are linked through a communications network.

It will be appreciated that more or fewer processes may be incorporated into the method illustrated in FIG. 2 without departing from the scope of the invention and that no particular order is implied by the arrangement of blocks shown and described herein. Therefore, in alternative embodiments, blocks 210 and 220 need not operate in parallel as shown in FIG. 2. It further will be appreciated that the method described in conjunction with FIG. 2 may be embodied in machine-executable instructions, e.g. software. The instructions can be used to cause a general-purpose or special-purpose processor that is programmed with the instructions to perform the operations described. Alternatively, the operations might be performed by specific hardware components that contain hardwired logic for performing the operations, or by any combination of programmed computer components and custom hardware components. The method may be provided as a computer program product that may include a machine-readable medium having stored thereon instructions which may be used to program a computer (or other electronic devices) to perform the method. For the purposes of this specification, the terms “machine-readable medium” shall be taken to include any medium that is capable of storing or encoding a sequence of instructions for execution by the machine and that cause the machine to perform any one of the methodologies of the present invention. The term “machine-readable medium” shall accordingly be taken to included, but not be limited to, solid-state memories, optical and magnetic disks, and carrier wave that encodes a data signal. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or a produce a result.

Although, the present invention was described in the context of a race car broadcast, the present invention is not so limited and is applicable to any kind of multimedia broadcast, including live, simulated, recorded broadcasts, or any combination thereof. Various types of broadcasts include a sports broadcast, a concert, a movie, a television program, and a play, among other examples.

The present invention allows the viewer to provide profile information and filters the incoming multimedia streams to present a personalized viewing experience according to the profile information. Specifically, the filter component 120 allows the display component 140 to present the appropriate multimedia streams, display the desired telemetry data, and any other information that is relevant to the user's profile information. In this way, the filtering process lowers the amount of information the viewer has to deal with and provides each viewer with a personalized experience of the same broadcast.

While the invention has been described in terms of several embodiments, those skilled in the art will recognize that the invention is not limited to the embodiments described. The method and apparatus of the invention can be practiced with modification and alteration within the spirit and scope of the appended claims. The description is thus to be regarded as illustrative instead of limiting the invention.

What is claimed is:

1. A method to filter a plurality of multimedia streams of a presentation comprising:
receiving user profile information describing user preferences;
receiving the plurality of multimedia streams including metadata describing each of the plurality of multimedia streams; and
filtering the plurality of multimedia streams to select a multimedia stream based on the metadata and the user profile information.

2. The method of claim 1 wherein the metadata describes characteristics of the plurality of multimedia streams.

3. The method of claim 1 wherein the metadata describes relationships of the plurality of multimedia streams.

4. The method of claim 1 wherein the selected multimedia stream is selected from the group consisting of an audio stream, a video stream, a graphics stream, a data stream, a simulated audio stream, a simulated video stream, and a simulated data stream.

5. The method of claim 1 further comprising:
generating a simulated multimedia stream associated with the selected multimedia stream; and
integrating the simulated multimedia into the selected multimedia stream.

6. The method of claim 5 wherein the integrating is performed after the filtering.

7. The method of claim 5 wherein the integrating is performed before the filtering.

8. The method of claim 1 further comprising:
presenting the selected multimedia stream to a display component.

9. The method of claim 1 further comprising:
transferring the selected multimedia stream to a data store.

10. The method of claim 1 wherein the user profile information is delivered via a viewer control.

11. The method of claim 1 wherein the presentation is selected from the group consisting of a sporting event, a concert, a movie, a television program, and a play.

12. The method of claim 1 wherein a subset of the plurality of multimedia streams are transmitted each from a plurality of broadcast cameras.

13. A filtering apparatus comprising:
a filter component to select a multimedia stream from a plurality of multimedia streams based on metadata and a user profile information.

14. The apparatus of claim 13 further comprising:
a display component to present the selected multimedia stream to a viewer.

15. The apparatus of claim 13 further comprising:
a data store to store the selected multimedia stream.

16. The apparatus of claim 13 further comprising:
a digital TV broadcast media from which the filter component receives the plurality of multimedia streams.

17. The apparatus of claim 13 wherein the filter apparatus is integrated into a system from the group consisting of a digital TV receiver, a set top box, and a personal computer.

18. The apparatus of claim 13 wherein the plurality of multimedia streams are selected from the group consisting of an audio stream, a video stream, a graphics stream, a data stream, a simulated audio stream, a simulated video stream, and a simulated data stream.

19. The apparatus of claim 13 further comprising:
a simulation server to generate and integrate simulated multimedia into the selected multimedia stream.

20. The apparatus of claim 13 further comprising:
a simulation server to generate and integrate simulated multimedia into the plurality of multimedia streams.

21. The apparatus of claim 13 further comprising:
a viewer control to provide user profile information to the filter component.

22. The apparatus of claim 21 wherein the viewer control selected from the group consisting of a television remote control and a graphical user interface.

23. A machine-readable medium having executable instructions to cause a machine to perform a method comprising:
receiving user profile information describing user preferences;
receiving a plurality of multimedia streams of a presentation including metadata describing each of the plurality of multimedia streams; and
filtering the plurality of multimedia streams to select a multimedia stream based on the metadata and the user profile information.

24. The machine-readable medium of claim 23 wherein the metadata describes characteristics of the plurality of multimedia streams.

25. The machine-readable medium of claim 23 wherein the metadata describes relationships of the plurality of multimedia streams.

26. The machine-readable medium of claim 23 wherein the selected multimedia stream is selected from the group consisting of an audio stream, a video stream, a graphics stream, a data stream, a simulated audio stream, a simulated video stream, and a simulated data stream.

27. The machine-readable medium of claim 23 further comprising:
generating a simulated multimedia stream associated with the selected multimedia stream; and
integrating the simulated multimedia into the selected multimedia stream.

28. The machine-readable medium of claim 27 wherein the integrating is performed after the filtering.

29. The machine-readable medium of claim 27 wherein the integrating is performed before the filtering.

30. The machine-readable medium of claim 23 further comprising:
presenting the selected multimedia stream to a display component.

31. The machine-readable medium of claim 23 further comprising:
transferring the selected multimedia stream to a data store.

32. The machine-readable medium of claim 23 wherein the user profile information is delivered via a viewer control.

33. The machine-readable medium of claim 23 wherein the presentation is selected from the group consisting of a sporting event, a concert, a movie, a television program, and a play.

34. The machine-readable medium of claim 23 wherein a subset of the plurality of multimedia streams are transmitted each from a plurality of broadcast cameras.
